(19) United States
(12) Patent Application Publication
(10) Pub. No.: US 2018/0232106 A1
(43) Pub. Date: Aug. 16, 2018

(54) VIRTUAL INPUT SYSTEMS AND RELATED METHODS

(71) Applicant: Shanghai Zhenxi Communication Technologies Co. Ltd., Shanghai (CN)

(72) Inventors: Xu Zhang, Shanghai (CN); Ming Zhao, Shanghai (CN)

(73) Assignee: Shanghai Zhenxi Communication Technologies Co. Ltd ., Shanghai (CN)

(21) Appl. No.: 15/594,551

(22) Filed: May 12, 2017

(30) Foreign Application Priority Data
Feb. 10, 2017 (CN) 201710073964.2

(51) Int. Cl. G06F 3/042; G06F 3/0354; G06F 3/0488; G06F 3/041

(52) U.S. Cl. CPC G06F 3/0426; G06F 3/03547; G06T 7/70; G06F 3/0418; G06T 2207/30204; G06F 3/04886

(57) ABSTRACT

A method for providing virtual input, the method comprising generating a plurality of image frames of a touchpad and a user's hand(s) adjacent to the touchpad; generating a user perceivable representation of a virtual input interface; detecting from the plurality of image frames one or more pointing devices associated with the user's hand; determining from the plurality of image frames a respective candidate target corresponding to each position of the one or more detected pointing devices; highlighting each respective candidate target determined from the plurality of image frames; detecting a respective touch point on the touchpad corresponding to each touch by one of the pointing devices on the touchpad; and determining a selected target by comparing the detected touch point with each respective candidate target determined from the plurality of image frames. Also disclosed is a system implementing the method disclosed herein.

### BACKGROUND

This application, and the innovations and related subject matter disclosed herein, (collectively referred to as the “disclosure”) generally concern systems and methods for providing user input via a virtual input interface that can be used in augmented reality (AR) or virtual reality (VR) technology.

Traditionally, a keyboard is one of the most commonly used input devices, through which a user can enter data or commands into a computing environment in order to, e.g., operate a computer or a program deployed on a computer. For example, through a keyboard, a user can enter data or commands by pressing one or more keys on the keyboard. The keys may correspond to characters, numbers, functional symbols, punctuation, etc. As used herein, the term “virtual keyboard” means a visual representation of—albeit non-existent as a physical component—a keyboard-like layout of keys that allows a user to interact with the visual representation to select desired keys for entering data or commands into a computing environment.

Others have attempted to develop techniques to provide a virtual keyboard for AR or VR applications. However, prior techniques suffer one or more shortcomings. One conventional technique for generating a virtual keyboard is based on real-time image processing of use's hand and/or finger movement. Under this approach, a system uses a camera to image a user's hands and/or fingers relative to any touch surface, such as a table top. The system continuously analyzes the movements of the hands and/or fingers relative to the touch surface in the camera's field of view. Based on the results of image analysis, the system can generate a virtual keyboard corresponding to the touch surface and interpret user's hand and/or finger movement as input on the virtual keyboard. While this approach may eliminate the need of a physical keyboard, it is associated with a number of disadvantages. For example, in order to determine the movement of the user's hands and/or fingers in a three-dimensional space, this technique requires using advanced algorisms for real-time image processing, which can increase computation complexity and electrical power consumption. Furthermore, the accuracy of determining user's input on the virtual keyboard is inherently limited based on image processing alone. These problems may be further aggravated by the position of the camera, for example, when the camera is located on a head-mounted device (HMD), such as a pair of smart glasses or goggles, the view angle of the camera in related to the user's hands and/or fingers leads to difficulties in obtaining the actual distance from fingers to the surface, distance less than a predefined value would be regarded as a touch.

Another conventional technique for generating a virtual keyboard is based on proximity sensing. Under this approach, a system uses a physical sensing interface which has sensors (e.g., capacitive sensors) that can detect the proximity and/or physical contact of user's hands and/or fingers. By placing user's hands and/or fingers close to the sensing interface, the system can detect the position and/or movement of the hands and/or fingers, based on which the system may interpret the user's intended input. However, this approach is also associated with a number of shortcomings. For example, to allow reliable sensing, the user must place his/her hands and/or fingers in close proximity to the sensing interface (e.g., within about 1-2 cm distance). Maintaining such a close distance for an extended period of time can cause fatigue and may even lead to ergonomic injuries. Furthermore, user may inadvertently touch the sensing interface despite his/her intention of maintaining the hovering position, leading to unintended user input.

Furthermore, while it is desired for a user input interface to achieve “what you see is what you get,” existing virtual keyboard technologies are not robust against erroneous user input. For example, even when the user decides to select an intended key, an erroneous input may be generated when the user attempts to confirm the selection because the system may detect the user's finger has inadvertently shifted to a different key other than the intended key before making the key selection. In addition, most existing virtual keyboard technologies do not offer the flexibility to dynamically change keyboard layout that can be adapted to specific applications, or dynamically adjust the size and/or position of the virtual keyboard so as to facilitate user input while not obscuring the content display in AR or VR.

Thus, a need remains for an improved virtual input technology that can provide an interface for efficient, accurate, reliable, and flexible user input to the AR or VR systems.

### SUMMARY

The innovations disclosed herein overcome many problems in the prior art and address one or more of the aforementioned or other needs. In some respects, the innovations disclosed herein are directed to method and system for providing virtual input, which may be used in an AR or VR system.

A method for providing virtual input can include generating a plurality of image frames of a touchpad and a user's hand(s) adjacent to the touchpad. The method can generate a user perceivable representation of a virtual input interface. One or more pointing devices associated with the user's hand can be detected from the plurality of image frames. A respective candidate target corresponding to each position of the one or more pointing devices can be determined from the plurality of image frames. Each respective candidate target determined from the plurality of image frames can be highlighted. The method can detect a respective touch point on the touchpad corresponding to each touch by one of the pointing devices on the touchpad. A selected target can be determined by comparing the detected touch point with each respective candidate target determined from the plurality of image frames.

In the foregoing and other embodiments, the determined candidate target can have a first coordinate position relative to the touchpad. The detected touch point can have a second coordinate position relative to the touchpad. Comparing the determined candidate target with the detected touch point can include calculating a distance between the first coordinate position and the second coordinate position.

In the foregoing and other embodiments, the selected target can be the candidate target whose first coordinate position has a smallest distance to the second coordinate position among all determined candidate targets.

In the foregoing and other embodiments, the virtual input interface can have a shape that is substantially identical to a shape of the touchpad, and the virtual input interface can have a dimension that is proportional to a dimension of the touchpad, such that each point on the virtual input interface can correspond to a unique point on the touchpad and each point on the touchpad can correspond to a unique point on the virtual input interface. In certain embodiments, the virtual input interface can have a layout of predefined targets, each target corresponding to a two dimensional area on the touchpad.

In the foregoing and other embodiments, the method can further detect a shape of the touchpad in the plurality of image frames and detect a marker on the touchpad. In certain embodiments, the method can determine a keyboard layout on the virtual input interface corresponding to the detected shape of the touchpad and the detected marker on the touchpad. In some embodiments, the marker can be displayable on the touchpad and can be updated by the user.

In the foregoing and other embodiments, determining the respective candidate target can include detecting a plurality of hover targets from the plurality of image frames. Each hover target can be detected from a corresponding image frame based on the position of the corresponding pointing device relative to the touchpad.

In the foregoing and other embodiments, the candidate target can be selected from the plurality of detected hover targets if the selected hover target satisfies a predetermined set of rules.

In the foregoing and other embodiments, the predetermined set of rules can describe a sequential pattern of and/or timing relationship between the plurality of hover targets detected from the plurality of image frames.

In the foregoing and other embodiments, the method can further display the user perceivable representation of the virtual input interface on a head-mounted device. In certain embodiments, the head-mounted device can be a pair of smart goggles or smart glasses.

In the foregoing and other embodiments, highlighting the candidate target can include generating a user perceivable representation of the candidate target based on a confidence score associated with the candidate target. The confidence score can measure a likelihood that the user intends to point to the candidate target using one of the pointing devices.

In the foregoing and other embodiments, the one or more pointing devices associated with the user's hand can include the user's fingers and/or an object that can generate a touch input to the touchpad by touching the touchpad.

In the foregoing and other embodiments, the virtual input interface can be a virtual keyboard. The candidate target can be a candidate key on the virtual keyboard. The selected target can be a selected key on the virtual keyboard.

Also disclosed is a system for providing virtual input. The system can include a camera adapted to generate a plurality of image frames of the touchpad and a user's hand(s) adjacent to the touchpad. The system can also include a keyboard projector adapted to generate a user perceivable representation of a virtual input interface. The system can further include a pointer detector adapted to detect from the plurality of image frames one or more pointing devices associated with the user's hand. The system can also include a key detector adapted to determine from the plurality of image frames a respective candidate target corresponding to each position of the one or more detected pointing devices. In addition, the system can include a key highlighter adapted to highlight each respective candidate target determined from the plurality of image frames. The system can also include a touchpad adapted to detect a respective touch point on the touchpad corresponding to each touch by one of the pointing devices on the touchpad. Further, the system can include a comparator adapted to determine a selected target by comparing the detected touch point with each respective candidate target determined from the plurality of image frames.

In the foregoing and other embodiments, the determined candidate target can have a first coordinate position relative to the touchpad, the detected touch point can have a second coordinate position relative to the touchpad, and comparing the determined candidate target with the detected touch point can include calculating a distance between the first coordinate position and the second coordinate position.

In the foregoing and other embodiments, the selected target can be the candidate target whose first coordinate position has a smallest distance to the second coordinate position among all determined candidate targets.

In the foregoing and other embodiments, the virtual input interface can have a shape that is substantially identical to a shape of the touchpad, and the virtual input interface can have a dimension that is proportional to a dimension of the touchpad, such that each point on the virtual input interface corresponds to a unique point on the touchpad and each point on the touchpad corresponds to a unique point on the virtual input interface. In certain embodiments, the virtual input interface can have a layout of predefined targets, each target corresponding to a two dimensional area on the touchpad.

In the foregoing and other embodiments, the system can further include a touchpad detector adapted to detect a shape of the touchpad in the plurality of image frames and detect a marker on the touchpad. In certain embodiment, the system can determine a keyboard layout on the virtual input interface corresponding to the detected shape of the touchpad and the detected marker on the touchpad. In some embodiments, the marker can be displayable on the touchpad and can be updated by the user.

In the foregoing and other embodiments, the key detector can be adapted to detect a plurality of hover targets from the plurality of image frames. Each hover target can be detected from a corresponding image frame based on the position of the corresponding pointing device relative to the touchpad.

In the foregoing and other embodiments, the key detector can be adapted to select the candidate target from the plurality of hover targets if the selected hover target satisfies a predetermined set of rules.

In the foregoing and other embodiments, the predetermined set of rules can describe a sequential pattern of and/or timing relationship between the plurality of hover targets detected from the plurality of image frames.

In the foregoing and other embodiments, the system can further include a display unit adapted to display the user perceivable representation of the virtual input interface on a head-mounted device. In certain embodiments, the head-mounted device can be a pair of smart goggles or smart glasses.

In the foregoing and other embodiments, the determined candidate target can be highlighted by a user perceivable representation of the candidate target based on a confidence score associated with the candidate target. The confidence score can measure a likelihood that the user intends to point to the candidate target using one of the pointing devices.

In the foregoing and other embodiments, the one or more pointing devices associated with the user's hand can include the user's fingers and/or an object that can generate a touch input to the touchpad by touching the touchpad.

In the foregoing and other embodiments, the virtual input interface can be a virtual keyboard. The candidate target can be a candidate key on the virtual keyboard. The selected target can be a selected key on the virtual keyboard.

The subject matter described herein for providing virtual input, including the method and system for generating the virtual input interface, highlighting the candidate targets, detecting the selected targets, etc., may be implemented in hardware, software, firmware, or any combination thereof. As such, the terms “units” or “module” as used herein refer to hardware, software, and/or firmware for implementing the feature being described.

The foregoing and other features and advantages will become more apparent from the following detailed description, which proceeds with reference to the accompanying drawings.

### BRIEF DESCRIPTION OF THE DRAWINGS

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation.

FIG. 1 schematically illustrates a user entering user input via a virtual keyboard.

FIG. 2 shows a block diagram of a system for providing input via a virtual keyboard.

FIG. 3 shows an exemplary keyboard layout of a virtual keyboard.

FIG. 4 shows an image of a touchpad with an overlying layout of a virtual keyboard.

FIG. 5 shows an example of a mapping table for a virtual keyboard.

FIG. 6 shows an image of a touchpad with two detected pointing devices.

FIG. 7 shows a process for providing input via a virtual keyboard.

FIG. 8 shows a process for detecting keys.

FIG. 9 shows a process for selecting keys.

FIG. 10 shows a schematic block diagram of a computing environment suitable for implementing one or more technologies disclosed herein.

### DETAILED DESCRIPTION

The following describes various innovative principles related to systems and method for providing virtual input. For example, certain aspects of disclosed subject matter pertain to systems and methods for providing a virtual keyboard interface that supports user's input in an AR or VR system, such as the smart goggles or glasses. Embodiments of such systems and methods described in context of AR or VR systems are but particular examples of contemplated systems and methods for virtual input and are chosen as being convenient illustrative examples of disclosed principles. One or more of the disclosed principles can be incorporated in various other systems for providing a virtual input interface to achieve any of a variety of corresponding system characteristics.

Thus, systems and methods for providing a virtual input and associated techniques, having attributes that are different from those specific examples discussed herein can embody one or more presently disclosed innovative principles, and can be used in applications not described herein in detail, for example, in meeting/conference presentation system, game consoles, and so on. Accordingly, such alternative embodiments can also fall within the scope of this disclosure.

### I. System Overview

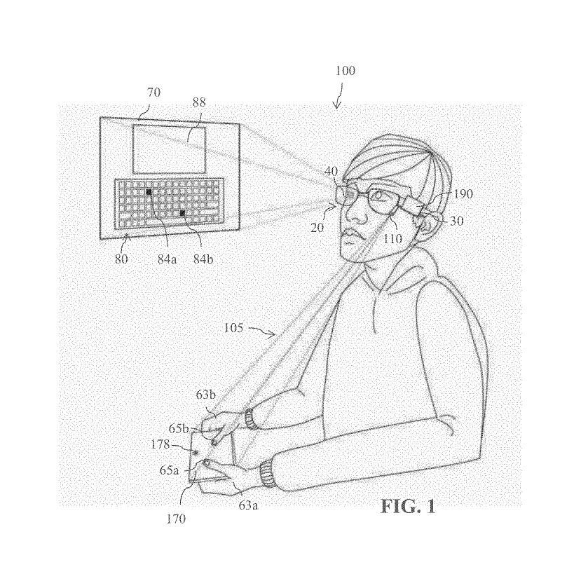

FIG. 1 schematically illustrates a user interacting with a system 100 to provide input via a virtual keyboard 80. The system 100 can include a touchpad 170 adapted to detect a touch point 175 (not shown) from the user's touch input. The system 100 can also include a camera 110 adapted to receive image input 105 and generate a plurality of image frames 115 (not shown) of a touchpad 170 and the user's hands 63a, 63b adjacent to the touchpad 170. The system 100 can also include a controller 190, which can detect one or more pointing devices, such as the user's fingers 65a, 65b from the plurality of image frames 115. The controller 190 can also determine respective candidate keys 84a, 84b from the plurality of image frames 115 corresponding to each of the one or more pointing devices 65a, 65b. The controller 190 can further determine a selected key 85 (not shown) by comparing the detected touch point 175 with the candidate key 84a, 84b corresponding to the pointing devices 65a, 65b. In addition, the system 100 can generate a user perceivable representation (e.g., an image, an array of illuminating pixels or light emitting devices, etc.) of a virtual keyboard 80, and highlight the candidate keys 84a, 84b on the virtual keyboard 80.

In this example, the camera 110 and the controller 190 are placed on a head-mounted device (HMD) 20, which has a frame 30 that can secure the HMD to the user's head. The HMD can have a display unit 40, through which the system 100 can generate a visual display 70 for the user to see. As known in the art, the display unit 40 can be a type of see-through, none see-through, or immersive display, based on the liquid crystal display (LCD), organic light-emitting diode (OLED), or liquid crystal on silicon (LCOS) technologies. As described herein, the display unit 40 can be placed in front of the user's right eye, left eye, or both eyes. Yet in certain embodiments, the display unit 40 may be optional. Instead of projecting the visual display 70 in front of the user's eye(s), the system 100 can project the visual display 70 directly to the user's retina. Depending on the application, the visual display 70 can show a field of content view 88 for displaying content (e.g., text documents, graphics, images, videos, or the combination thereof, etc.), and the virtual keyboard 80 for entering user's input. The virtual keyboard 80 can be properly sized and/or placed in the visual display 70 so that it does not overlap or interfere with the field of content view 88. Thus, to provide input to the system 100, the user only need to focus on the virtual display 70 without the need of line-of-sight tracking of the actual moving fingers on the touchpad 170. This is suitable for AR or VR which needs human eyes to focus on virtual information instead of the physical input interface. It may also improve the input efficiency and prevent eye fatigue.

In some embodiments, the system 100 can have a synthesizer 180 (not shown) that is adapted to project the content view 88 and/or the virtual keyboard 80 on the visual display 70. The system 100 can also use the synthesizer 180 to highlight the candidate keys 84a, 84b on the virtual keyboard 80 to provide visual feedback to the user. In certain other embodiments, the camera 110, the synthesizer 180, or the controller 190 may not be disposed on an HMD 20. In certain embodiments, the camera 110 and/or the synthesizer 180 may be integrated with the controller 190 in a single module.

### II. System Components

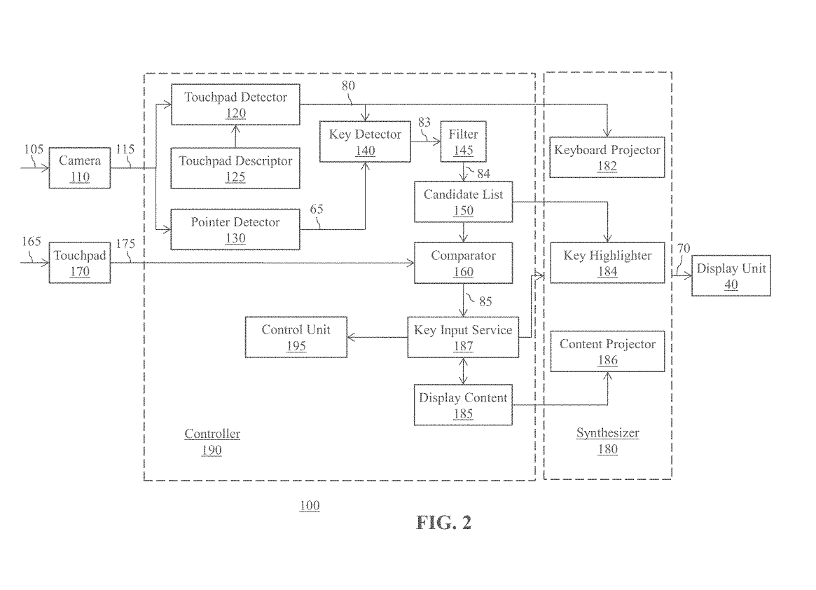

FIG. 2 shows an exemplary block diagram of the system 100 for providing input via the virtual keyboard.

As shown in FIG. 2, the system 100 can include a touchpad 170 adapted to receive touch input 165 from the user and detect a touch point 175 which represents a location on the touchpad where the user touches by using one of the pointing devices. For example, the touchpad 170 may include a touch surface that can sense a touch of the user's finger or a stylus pen, and generate data representing the position or coordinates of the sensed pressing point.

The system 100 can also have a camera 110 adapted to receive image input 105. According to some typical embodiments, the camera 110 can have a field of view containing at least the touchpad 170. Accordingly, the camera 110 can generate a plurality of image frames 115 of the touchpad 170 and a user's hands 63a, 63b adjacent to the touchpad 170. According to certain embodiments, the camera 110 does not need to be oriented perpendicular to the touchpad 170. This can be helpful when the camera 110 is located on a HMD, so that a user wearing the HMD can freely move the head within a reasonable range while the camera 110 can still capture the images of the touchpad 170. Similarly, the user can freely move the touchpad 170 within a reasonable range while still ensuring the touchpad 170 is within the camera's field of view. In capturing the images of the touchpad 170, the number of frames per second captured by the camera 110 may determine the frequency at which the system 100 can perform key detections (e.g., detecting hover keys and determining candidate keys as described more fully below.)

The system 100 can include a synthesizer 180 adapted to generate a visual display 70. The synthesizer 180 can include a keyboard projector 182 adapted to generate a virtual keyboard 80, a key highlighter 184 adapted to highlight the candidate keys 84 on the virtual keyboard 80, and a content projector 186 adapted to generate the field of content view 88. In some embodiments, the visual display 70 can be presented to the user via a display unit 40. In some embodiments, the visual display 70 can be projected directly into the user's retina. The visual display 70 allows the user to interact with the virtual keyboard 80 and control the display in the field of content view 88.

The system 100 can further include a controller 190 adapted to control various aspects of system operations, such as detecting one or more pointing devices 65, determining one or more candidate keys 84, determining selected keys 85, etc. For example, the controller 190 can include a pointer detector 130 adapted to detect one or more pointing devices 65 associated with the user's hand from the plurality of image frames 115. The controller 190 can also include a key detector 140 adapted to determine from the plurality of image frames a respective candidate key 84 corresponding to each position of the one or more pointing devices 65. Further, the controller 190 can include a comparator 160 adapted to determine a selected key 85 by comparing the detected touch point 175 with each respective candidate key 84 determined from the plurality of image frames.

In certain embodiments, the key detector 140 is adapted to detect a plurality of hover keys 83 from the plurality of image frames 115 for each of the one or more pointing devices 65. Each hover key 83 can be detected based on a position of the pointing device 65 relative to the touchpad in a corresponding image frame 115. The controller 190 can include a filter 145, which can be adapted to select the candidate keys 84 from the plurality of hover keys 83 based on a predetermined set of rules. The determined candidate keys 84 can be maintained in a candidate list 150, which can be used by the comparator 160 to determine the selected key 85. The key highlighter 184 can also highlight the candidate keys 84 maintained in the candidate list 150.

In certain embodiments, the controller 190 can include a touchpad detector 120 adapted to detect a shape of the touchpad 170 in the plurality of image frames 115 and detect a marker 178 on the touchpad. In some embodiments, the touchpad detector 120 is adapted to initially detect the marker 178, and then detect the touchpad 170 by surveying an area surrounding the marker 178. Since the marker 178 can be predefined uniquely for easy detection, the task of touchpad detection can be simplified by detecting the maker first and then limiting the search of touchpad to an area adjacent the marker. The controller 190 can further include a touchpad descriptor 125 which can define a specific keyboard layout on the virtual keyboard 80 corresponding to each combination of a shape of the touchpad 170 and a marker 178 on the touchpad. Accordingly, the touchpad detector 120 can be adapted to determine a keyboard layout on the virtual keyboard 80 corresponding to the detected shape of the touchpad 170 and the detected marker 178 on the touchpad. In other embodiments, the keyboard layout of the virtual keyboard 80 can be predefined.

In certain embodiments, the marker 178 can be displayable on the touchpad 170 and can be updated by the user. For example, the marker 178 can be an external element having a predefined pattern (e.g., shape, color, etc.) that can be detachably attached to the touchpad 170 by the user via gluing, sticking, clipping, clasping, etc. Alternatively, the marker 178 can be presented by a display unit (e.g., LED, LCD, etc.) embedded or attached to the touchpad 170, and the user can control or program the display unit to generate or update the marker 178 dynamically or on demand. This feature is contemplated to be advantageous because it allows a user to change the keyboard layout, e.g., by updating the marker, on the fly while viewing and/or interacting with the AR or VR contents. By way of example, and not limitation, the user may have the flexibility to switch between a standard QWERT keyboard layout, an arrow keyboard (e.g., up, down, left, right), a numerical keyboard (e.g., phone key pad), and other customized keyboards, by simply changing the marker 178 on the touchpad 170.

Since both the camera 110 and the touchpad 170 may change in location and/or angle from time to time, the images of the touchpad and/or the user's pointing devices in the plurality of image frames 115 may differ over time. For example, the touchpad and/or the user's fingers may appear at different locations and/or with different perspectives, e.g., with changing three-dimensional tilt angles, in the plurality of image frames 115. The pointer detector 130 and/or the touchpad detector 120 can be adapted to process the plurality of image frames 115 to compensate for or correct such location and/or perspective changes. In certain embodiments, the marker 178 on the touchpad 170 may be used as a position reference in image processing to compensate for or correct the location and/or perspective changes in the plurality of image frames 115. By compensating for or correcting the location and/or perspective changes in the plurality of image frames 115, the key detector 140 can more accurately detect the hover keys 83 based on the position of the pointing devices 65 relative to the touchpad in the plurality of image frame 115.

In certain embodiments, the controller 190 can include a key input service module 187 which is activated upon the determination of a selected key 85. The key input service module 187 can be configured to actuate a plurality of functions of the system 100. For example, based on the selected key 85, the key input service module 187 can retrieve or control the display content 185 that is sent to the content projector 186 for displaying, to control the appearance of the virtual keyboard 80 (e.g., size, location, ON/OFF status, etc.) and key highlighting properties (e.g., key color, shade, size, animation, etc.), to update the marker 178 on the touchpad 170, to adjust system parameters (e.g., sensitivity settings of the camera 110 or touchpad 170, turning ON/OFF certain system functions, etc.) via a controller unit 195, and so on.

It should be understood that the block diagram shown in FIG. 2 represents only one exemplary embodiment of the inventive subject matter. Other embodiments can be implemented based on the same general principles described herein. For example, some of the modules or units described herein may be combined in an integrated module or unit. In an exemplary, non-limiting embodiment, the filter 145 may be embedded in the key detector 140. Alternatively, some of the individual module or unit described herein may be separated into one or more submodules or subunits. In addition, some of the modules or unites may be configured in a different structure. For example, in some embodiments, the display content 185 may be a component of the synthesizer 180 rather than the controller 190, or the key highlighter 184 may be part of the controller 190 rather than the synthesizer 180, and so on. In certain embodiments, some of the modules or units described herein may be optional. In other embodiments, the system 100 may include additional modules or units (e.g., auditory input/output, wireless communication, etc.) for implementing specific functions.

### III. Layout and Mapping of Virtual Keyboard

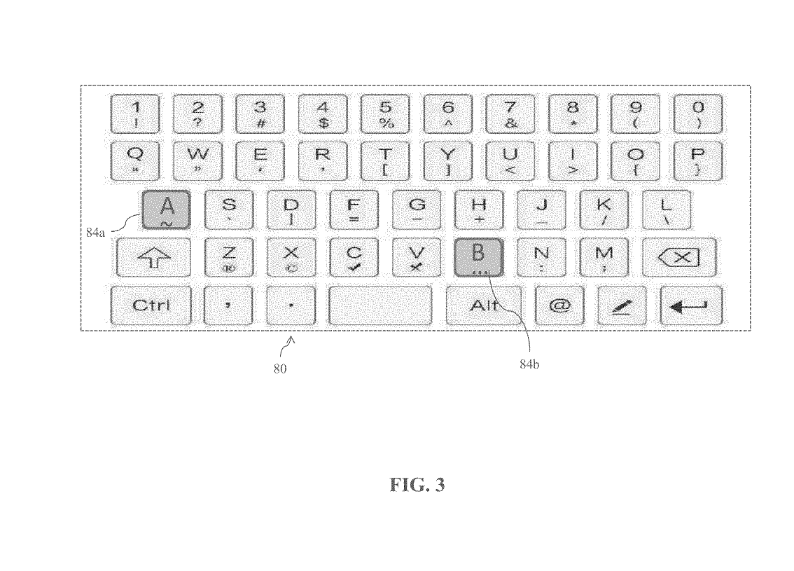

FIG. 3 shows an exemplary keyboard layout of a virtual keyboard 80, where a predefined set of keys are distributed in a two-dimensional (2D) space. Some of the keys may correspond to more than one key entry so as to support combination keys based on the sequence of key selection (e.g., number “1” can share the same key as symbol “!” which can be entered by using the key combination of SHIFT+“1”, etc.). For illustration purposes, two keys “A” and “B” are highlighted, representing two candidate keys 84a, 84b that the user may potentially select as input. As described more fully below, the candidate keys 84a, 84b correspond to respective pointing devices, and can be automatically determined by the key detector 140 from the plurality of image frames 115. The key highlighter 184 can highlight the candidate keys 84a, 84b by changing one or more properties of the keys on the virtual keyboard 80. For example, the candidate keys 84a, 84b can be highlighted through button flashing, color changes, overlay icons and/or button bulge, or any other user perceivable manners (e.g., visual cues, audible sound, tactile feedback, etc.), to inform the user that the corresponding keys are candidates for the user to select.

In some embodiments, the keyboard layout of the virtual keyboard 80 can be predefined and fixed. In other embodiments, the keyboard layout of the virtual keyboard 80 can be adaptive to the touchpad 170, so that a specific keyboard layout can correspond to a combination of the shape of the touchpad 170 and the marker 178 on the touchpad as defined by the touchpad descriptor 125. For example, the touchpad 170 may be designed to have a variety of regular shapes (e.g., square, rectangular, trapezoidal, circular, oval, etc.) or irregular shapes, and the marker 178 may also vary (e.g., in shape, pattern, color, etc.). Based on the detected shape of the touchpad 170 and/or the marker 178, the touchpad detector 120 can generate a corresponding keyboard layout for the virtual keyboard 80. This feature may be helpful in some applications where the system 100 can automatically select a matching keyboard layout for a specific touchpad (e.g., with a predefined shape and marker) customarily designed for the application. The contemplated benefits may include, but are not limited to, improving the efficiency of user input (e.g., some applications may only need a selected subset of keys arranged in a specific pattern), enhancing the security of the system (e.g., a user can only interact with the system and view the AR or VR content by using an authorized touchpad that have a required shape and marker), and so on.

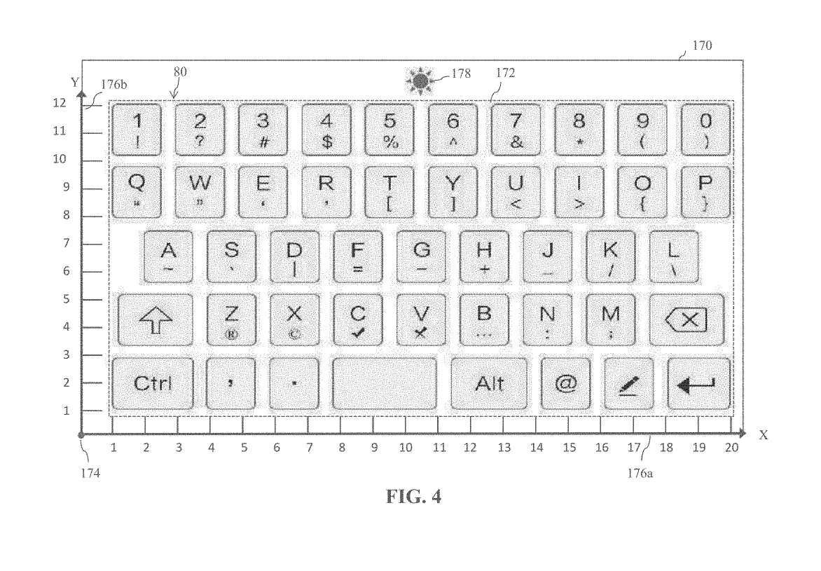

FIG. 4 shows an exemplary touchpad 170 together with an overlying virtual keyboard 80. The virtual keyboard 80 in FIG. 4 is shown for reference. There is no need to display it on the actual touchpad 170. The touchpad 170 has a touch surface 172 and a marker 178. As described above, the marker 178, which may provide information associated with the touchpad 170, can be captured by the camera 110 and detected by the touchpad detector 120. The marker 178 can be located on the touchpad 170 where it is unlikely to be covered by the user's hands, e.g. a place outside the touch surface 172. In certain embodiments, the marker 178 may be invisible to a human's eye. In certain embodiment, the marker 178 may include non-optical communication parts to identify the touchpad 170. In an exemplary, non-limiting example, the marker 178 may include an additional radio-frequency identification (RFID) component that can be detected and recognized by the controller 190, wherein the RFID component may contain specification information (e.g., shape, size, keyboard layout, etc.) regarding the touchpad 170.

In some embodiments, the virtual keyboard 80 can have a shape that is substantially identical to a shape of the touchpad 170, and the virtual keyboard 80 can have a dimension that is proportional to a dimension of the touchpad 170, such that each point on the virtual keyboard 80 corresponds to a unique point on the touchpad 170 and each point on the touchpad 170 corresponds to a unique point on the virtual keyboard 80. In certain embodiments, the touch surface 172 may cover most or entire surface of the touchpad 170. As described herein, the dimension of the touchpad 170 can also refer to the dimension of the touch surface 172. In the example shown in FIG. 4, the virtual keyboard 80 has the same shape and dimension as the touch surface 172. However, the virtual keyboard 80 can have a different dimension than the touch surface 172. For example, the virtual keyboard 80 can be a scaled representation of the touch surface 172 (e.g., if the touch surface 172 has a rectangular shape, the width and length of the virtual keyboard 80 can be proportional to the respective width and length of the touch surface 172). Thus, by applying appropriate scaling factors, one-to-one positional correspondence between the touch surface 172 and the virtual keyboard 80 can be established.

As illustrated in FIG. 4, the touchpad 170 and the area of touch surface 172 can be characterized by a coordinate system in a 2D space. In a representative, non-limiting example, the touchpad 170 and touch surface 172 are shown to have the rectangular shape: the length is along an x-axis 176a, the width is along a y-axis 176b, and an origin 174 is defined around the lower-left corner of the touchpad 170. Thus, every point on the touchpad 170 or touch surface 172 can be defined by a pair of touchpad coordinates. Based on the marker 178 and the shape of the touchpad 170, a corresponding coordinate system (e.g., x-axis, y-axis, and origin) can be established for the virtual keyboard 80, so that every point on the virtual keyboard 80 can be defined by a pair of virtual keyboard coordinates. As described above, the coordinate system of the virtual keyboard 80 can be scaled proportionally relative to the coordinate system of the touch surface 172.

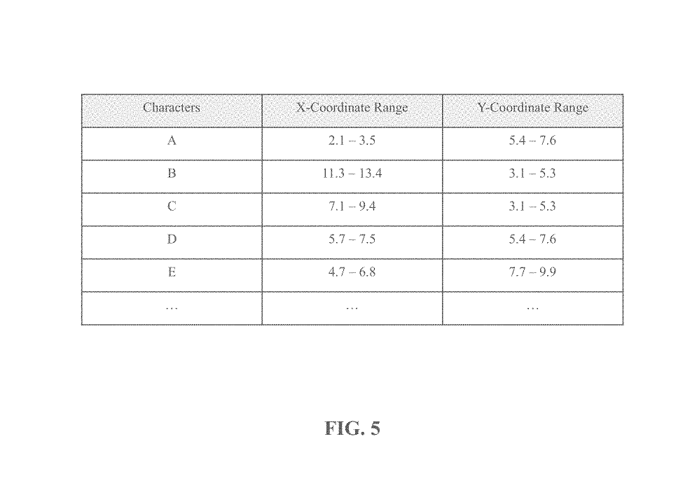

In some embodiments, the virtual keyboard 80 can have a layout of predefined keys wherein each key can correspond to a 2D area on the touchpad 170. Such a positional correspondence can be predefined by a keyboard mapping table. FIG. 5 shows one exemplary keyboard mapping table, which map different areas on the touchpad 170 to different characters, e.g. based on the exemplary touch surface 172 with a size of 12 x 20 (arbitrary unit) shown in FIG. 4. In some embodiments, a plurality of keyboard mapping tables corresponding to different keyboard layouts can be defined by the touchpad descriptor 125.

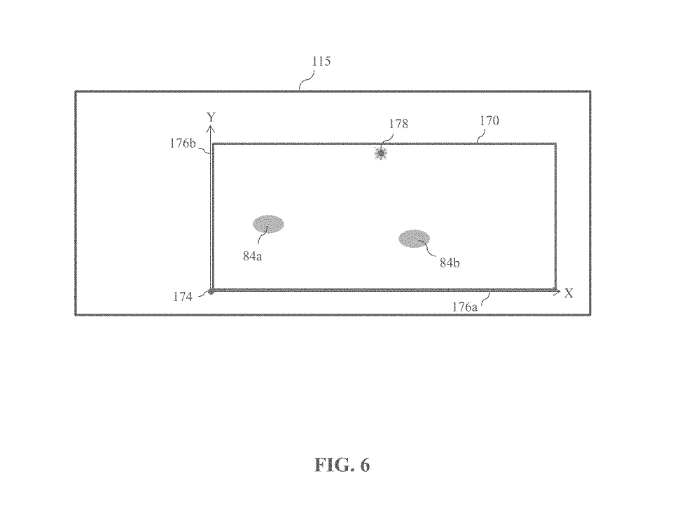

Accordingly, when the pointer detector 130 detects that the user's pointing device 65 is hovering above a certain position of the touchpad 170 from one of the image frames 115, the key detector 140 can determine the matching key corresponding to that position area based on the keyboard mapping table, and use that matching key to detect the corresponding hover key 83 and further determine the candidate key 84. For example, FIG. 6 shows one of the image frames 115 captured by the camera 110. The image frame 115 shows an image of the touchpad 170 and two detected pointing devices 84a, 84b. As described above, the system 100 can detect the shape of the touchpad 170 and the marker 178 on the touchpad 170. Accordingly, the system 100 can determine the x-axis 176a, y-axis 176b, and origin 174 of the corresponding coordinate system. Thus, the position for each of the detected pointing devices 84a, 84b relative to the touchpad 170 can be described by respective (x, y) coordinates, and its corresponding key on the virtual keyboard 80 can be determined based on the keyboard mapping table. For example, in FIG. 6, the detected pointing devices 84a and 84b have coordinates (3.1, 6.1) and (12.6, 4.7), respectively. Based on the exemplary keyboard mapping table shown in FIG. 5, the system 100 can determine that pointing devices 84a and 84b respectively correspond to the keys “A” and “B” on the virtual keyboard 80.

### IV. Process Overview

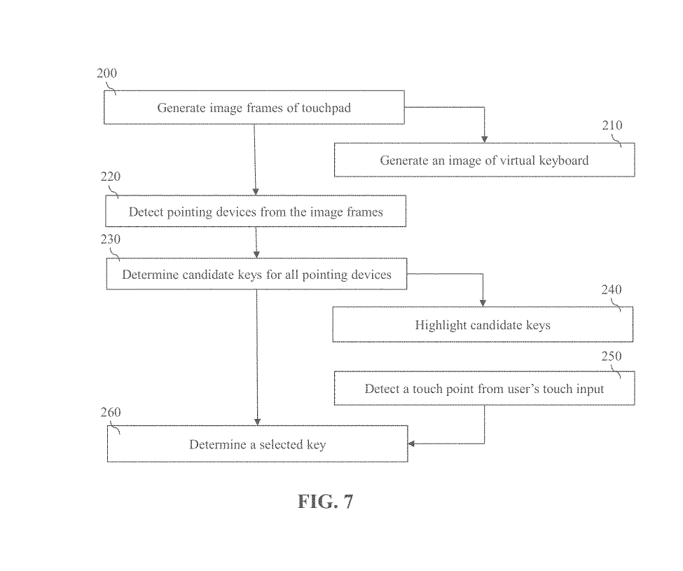

FIG. 7 shows a flowchart illustrating an exemplary process of providing input via a virtual keyboard. In certain embodiments, some of the steps shown in the flowchart may be combined, or shown in different sequences.

At 200, the camera can generate a plurality of image frames of the touchpad and a user's hand(s) adjacent to the touchpad in real time. Based on the captured image frames, the system can generate an image of a virtual keyboard at 210. As described above, the keyboard layout on the virtual keyboard may be predefined, or adaptive to the shape of the touchpad and the marker on the touchpad. At 220, one or more pointing devices of the user's hand can be detected from the plurality of image frames. At 230, the system can determine a candidate key from the plurality of image frames corresponding to each of the one or more pointing devices. At 240, the determined candidate key corresponding to each of the one or more pointing devices can be highlighted on the virtual keyboard. The user may continuously move the pointing devices around until one of the highlighted candidate keys in the virtual keyboard is the key the user selects to input. The user then presses or touches the touchpad with the pointing device corresponding to the candidate key selected. After detecting a touch point on the touchpad from the user's touch input at 250, the system can determine the selected key at 260 by comparing the candidate key corresponding to each of the one or more detected pointing devices with the detected touch point.

### V. Key Detection

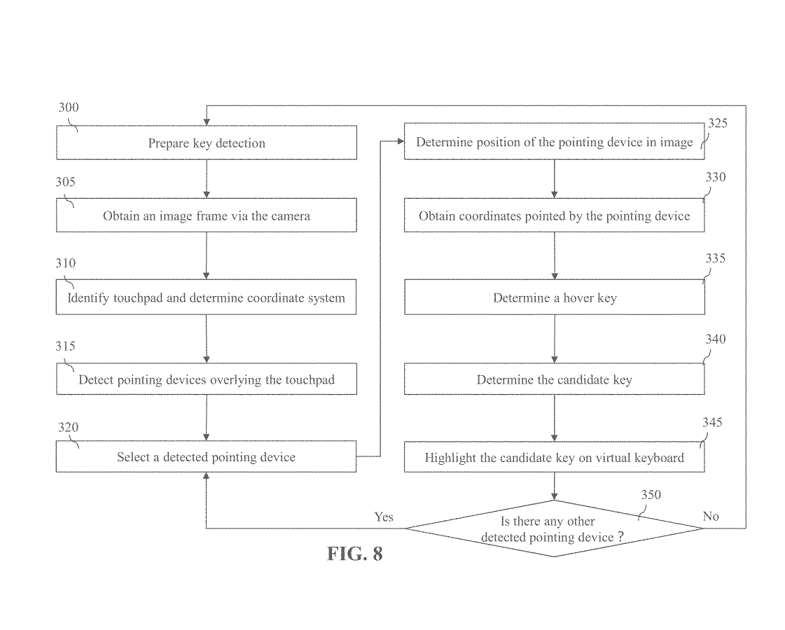

FIG. 8 shows a flowchart illustrating an exemplary process of key detection. In certain embodiments, some of the steps shown in the flowchart may be combined, or shown in different sequences.

Key detection can be generally implemented based on real-time analysis of the sequential image frames acquired by the camera. To prepare key detection at 300, certain initialization operations can be performed, for example, reset certain operating parameters, clear previously detected hover keys and/or candidate keys, etc. At 305, a new image frame acquired by the camera is retrieved for analysis. The image frame can be preprocessed to remove background noise. In addition, the image frame can also be processed to compensate for or correct the positional and/or angular changes of the camera relative to the touchpad.

At 310, the system can detect the touchpad from the image frame. As described above, based on the detected touchpad, the layout of the corresponding virtual keyboard can be determined. The coordinate systems for the touchpad and the virtual keyboard, as well as the corresponding mapping table can also be determined. If the detected touchpad remains the same as that in previous image frames, no update is necessary. Otherwise (e.g., a new touchpad with a different shape and/or a different marker on the touchpad is detected), the system can update the virtual keyboard layout, the coordinate systems for the touchpad and the virtual keyboard, and the associated mapping table.

At 315, all pointing devices overlying the touchpad can be detected from the image frame. This can be implemented by conventional pattern recognition techniques as known in the art. For example, the system may maintain a template image and/or a set of quantitative features (e.g., geometric metrics, shape, shade, etc.) that characterize each of the system-supported pointing devices. A pointing device can be detected if an object within the image frame substantially matches one of the template images and/or the set of quantitative features. In certain embodiments, the pointing devices may be user's fingers. In certain embodiments, the pointing devices may be stylus pens or other touchpad input devices that are supported by the system.

Each of the detected pointing devices is selected at 320 for further analysis. At 325, the position of the pointing device relative to the touchpad in the image frame is determined. Then at 330, based on the coordinate system for the touchpad, the (x_{T}, y_{T}) coordinates pointed by the pointing device on the touchpad can be obtained. At 335, using the mapping table, the key corresponding to the (x_{T}, y_{T}) coordinates can be determined as a hover key. As described herein, a hover key refers to a key on the virtual keyboard with a mapped touchpad area over which a pointing device is detected to hover in at least one image frame.

At 340, the candidate key corresponding to the pointing device is determined. As described herein, a candidate key refers to a key which is highlighted on the virtual keyboard so that the user may potentially select as an input to the system. Note that a candidate key is a hover key, but a hover key may not necessarily be a candidate key. For example, the user may not be able to hold his hand in a perfectly stable position, and consequently may inadvertently hover the pointing device over multiple keys. Such conditions are more likely to occur when the pointing device hovers over the boundary between two or more adjacent keys—the system may detect different hover keys in several consecutive image frames although the user may intend to point to only one candidate key. To improve reliability and accuracy of the user input, it is important to distinguish candidate keys from non-candidate hover keys. In some embodiments, a candidate key can be selected from the plurality of hover keys if the selected hover key satisfies a predetermined set of rules. In some embodiments, the predetermined set of rules can describe a sequential pattern of and/or timing relationship between a plurality of hover keys detected from a plurality of image frames.

In a representative, non-limiting embodiment, the system may detect N hover keys from N consecutive image frames and maintain them in a buffer, where N can be a predefined or user-programmable parameter. Denote these N hover keys as [K(1), K(2), . . . , K(N)], where K(i) represents the i-th hover key from the i-th image frame (i=1 . . . N). Any of the N hover keys may be the same as or different from other hover keys. To determine whether K(N) (assuming it is the hover key detected in the present image frame) qualifies as a candidate key, K(N) can be compared with other hover keys detected from previous image frames and stored in the buffer (i.e., K(1), K(2), . . . , K(N−1)), and assess whether K(N) satisfies the predetermined set of rules. By way of example, and not limitation, one of the rules may require that a candidate key shall remain as the same hover key for a consecutive number m (m≤N) of image frames. Another rule may require that a candidate key shall be detected as the same hover key in x-out-of-y image frames (x≤y≤N). An alternative rule may require that a candidate key shall be the most frequently detected hover key in the previous n (n≤N) image frames. In addition, a rule may require that a previously determined candidate key shall not be updated unless certain predefined time duration has elapsed. Thus, certain hysteresis effect can be created for the system to determine and/or update the candidate keys. Yet a further rule may require that the spatial distance between a candidate key and the hover keys detected in the previous image frames shall meet certain predefined criteria. Other rules may be defined based on the same or similar principles. Any of those rules may be combined using any logical relationship (e.g., AND, OR, etc.) to form a new rule.

If the hover key detected at 335 meets the predetermined set of rules, it can be determined to be the candidate key at 340. Accordingly, the candidate key can be highlighted on the virtual keyboard at 345. At 350, a conditional check is performed to see if there are any additional pointing devices that need to be analyzed. If yes, then the process branches to 320 and repeats the analysis for another pointing device. Otherwise, the candidate keys corresponding to all pointing devices are determined, and the process returns to 300 to prepare for the next key detection. The system can maintain a candidate list 150 that includes all determined candidate keys for key selection as described more fully below. It is contemplated to be advantageous to support multiple pointing devices for virtual keyboard input, which can improve the input speed. For example, if the touch pad is big enough to accommodate two hands, then a user can use ten fingers for typing, each of the fingers can cover one or several corresponding keys. Alternatively, a user can use left and right thumbs to cover keys on the left and right half of the virtual keyboard, respectively.

In some embodiments, the candidate key determined at 340 can be associated with a confidence score, and the candidate key can be highlighted by determining a user perceivable representation of the candidate key based on the confidence score. For example, the candidate key associated with different confidence score can be highlighted at 345 by using different highlighting properties. The confidence score can reflect a measurement of likelihood that the candidate key is the key to which the user intends to point. By way of example, and not limitation, if the candidate key is detected to be the same hover key in k (k≤N) image frames in the buffer, the confidence score can be defined as k/N or a similar metric. Accordingly, the detected candidate key can be highlighted in different formats (e.g., varying size, color, shade, etc.) associated with the confidence score, so that the user can receive feedback regarding the probability or reliability of pointing to the intended key, and move the pointing devices to correct the pointing position if necessary.

### VI. Key Selection

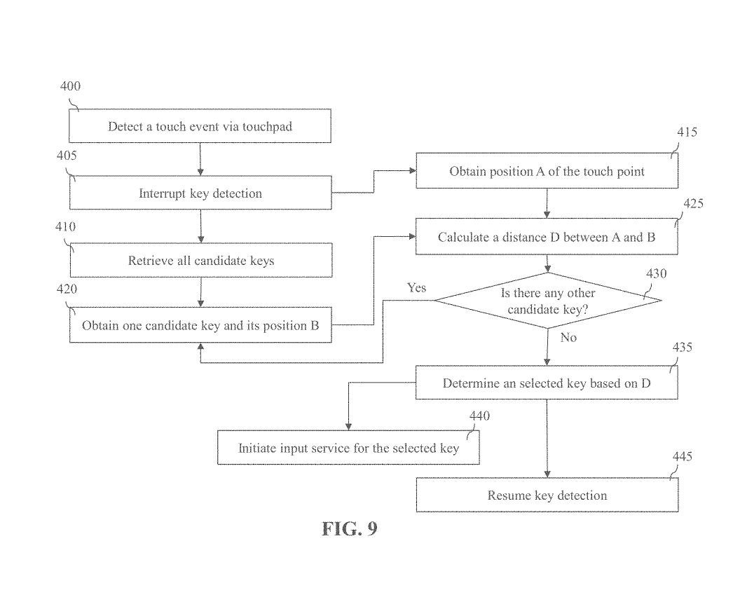

FIG. 9 shows a flowchart illustrating an exemplary process for selecting keys. In certain embodiments, some of the steps shown in the flowchart may be combined, or shown in different sequences.

As described above, the key selection can be implemented by a comparator 160, which determines the selected key by comparing the candidate keys detected from the image frames with the touch point detected from the touchpad. At 400, a touch event via the touchpad is detected. At 405, the system temporarily interrupts the key detection process illustrated in FIG. 8. At 410, the system can retrieve from the candidate list all determined candidate keys corresponding to all pointing devices. At 415, the system can obtain the position A of the detected touch point on the touchpad. For example, based on the coordinate system of the touchpad, the position A of the touch point relative to the touchpad can be described by a pair of touchpad coordinates (x_{A}, y_{A}).

At 420, the system selects one candidate key and obtains its position B. As described above, a candidate key is selected from one of the hover keys pointed by a pointing device. Thus, the position B of the candidate key can be represented by the coordinates (x_{V}, y_{V}) on the virtual keyboard determined by the pointing device. Alternatively, each key on the virtual keyboard can be assigned a corresponding pair of coordinates (x_{V}, y_{V}) reflecting its position on the virtual keyboard. For example, each key may be the assigned coordinates corresponding to the centroid (geometry center) of the key. Accordingly, the position B of the candidate key can be represented by the coordinates of its centroid on the virtual keyboard.

At 425, a distance D between position A and position B is calculated. The calculation of distance can be performed based on the touchpad coordinate system. As described above, one-to-one positional correspondence between the touchpad and the virtual keyboard can be established (e.g., by applying appropriate scaling factors). Thus, the position B of the candidate key can be converted to the touchpad coordinates (x_{B}, y_{B}) from the virtual keyboard coordinates (x_{V}, y_{V}). Accordingly, the distance D between coordinate position A (x_{A}, y_{A}) and coordinate position B (x_{B}, y_{B}) can be calculated using any of the conventional distance metrics, such as the Euclidian distance, the city block distance, and so on. Alternatively, the touchpad coordinates (x_{A}, y_{A}) can be converted to the virtual keyboard coordinates, and the calculation of distance can be performed base on the virtual keyboard coordinate system.

At 430, a conditional check is performed to see if there are any additional candidate keys need to be analyzed. If yes, then the process branches to 420 to retrieve another candidate key and repeats the distance calculation. Otherwise, the process proceeds to 435 to identify the selected key. In an exemplary, non-limiting embodiment, the candidate key having the smallest distance D is determined to be the selected key. For example, denote (B₁, B₂, . . . , Bₖ) the positions of k candidate keys maintained in the candidate list, and denote (D₁, D₂, . . . , Dₖ) the calculated distances between the touch point position A and the position of the respective candidate key. The candidate key corresponding to the minimum of (D₁, D₂, . . . Dₖ) can be determined as the selected key. In other words, assuming there are multiple pointing devices, each of which has a corresponding candidate key. After detecting a touch event via the touchpad, the system can automatically determine the selected key by evaluating which candidate key is closest to the touch point on the touchpad.

Key selection based on the comparison of candidate keys with the touch point can simplify the system operation and improve the robustness of user input via the virtual keyboard. For example, when the user decides to select a highlighted candidate key, the user's pointing device may have inadvertently shifted to a different location other than the highlighted candidate key before touching the touchpad. By selecting the candidate key that is closest to the touch point, the system can ignore such an erroneous input and still correctly select the intended key input (i.e., the highlighted key that is closest to the touch point). In addition, by leveraging the disparate and complimentary information received from both the optical input (e.g., camera image frames) and the tactile input (e.g., touch point position), the system may relax or lower some hardware and/or software requirements, e.g., touchpad's resolution, camera's resolution, complexity and/or precision of the image processing algorithms, etc., thus improving efficiency while reducing the overall complexity and cost of the system.

After the selected key is determined, the system can initiate input service for the selected key at 440, and resume key detection at 445. Depending on which key is selected, the input service can trigger different functions. For example, based on the selected key, the key input service can enter text input via the virtual keyboard, control the display content, change the appearance of the virtual keyboard and key highlighting properties, adjust system parameters, and so on.

### VII. Computing Environment

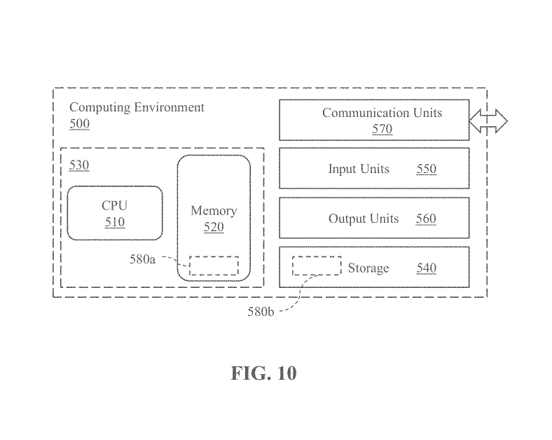

FIG. 10 illustrates a generalized example of a suitable computing environment 500 in which described methods, embodiments, techniques, and technologies relating, for example, to virtual input can be implemented. The computing environment 500 is not intended to suggest any limitation as to scope of use or functionality of the technologies disclosed herein, as each technology may be implemented in diverse general-purpose or special-purpose computing environments. For example, each disclosed technology may be implemented with other computer system configurations, including wearable and handheld devices (e.g., a mobile-communications device), multiprocessor systems, microprocessor-based or programmable consumer electronics, embedded platforms, network computers, minicomputers, mainframe computers, smartphones, tablet computers, video game consoles, game engines, video TVs, and the like. Each disclosed technology may also be practiced in distributed computing environments where tasks are performed by remote processing devices that are linked through a communications connection or network. In a distributed computing environment, program modules may be located in both local and remote memory storage devices.

The computing environment 500 includes at least one central processing unit 510 and memory 520. In FIG. 10, this most basic configuration 530 is included within a dashed line. The central processing unit 510 executes computer-executable instructions and may be a real or a virtual processor. In a multi-processing system, multiple processing units execute computer-executable instructions to increase processing power and as such, multiple processors can run simultaneously. The memory 520 may be volatile memory (e.g., registers, cache, RAM), non-volatile memory (e.g., ROM, EEPROM, flash memory, etc.), or some combination of the two. The memory 520 stores software 580a that can, for example, implement one or more of the innovative technologies described herein, when executed by a processor.

A computing environment may have additional features. For example, the computing environment 500 can include storage 540, one or more input units 550, one or more output units 560, and one or more communication units 570. An interconnection mechanism (not shown) such as a bus, a controller, or a network, interconnects the components of the computing environment 500. Typically, operating system software (not shown) provides an operating environment for other software executing in the computing environment 500, and coordinates activities of the components of the computing environment 500.

The storage 540 may be removable or non-removable, and can include selected forms of machine-readable media. In general machine-readable media includes magnetic disks, magnetic tapes or cassettes, non-volatile solid-state memory, CD-ROMs, CD-RWs, DVDs, optical data storage devices, and carrier waves, or any other machine-readable medium which can be used to store information and which can be accessed within the computing environment 500. The storage 540 stores instructions for the software 580b, which can implement technologies described herein.

The storage 540 can also be distributed over a network so that software instructions are stored and executed in a distributed fashion. In other embodiments, some of these operations might be performed by specific hardware components that contain hardwired logic. Those operations might alternatively be performed by any combination of programmed data processing components and fixed hardwired circuit components.

The input unit(s) 550 may include a physical input device, such as a button, a pen, a mouse or trackball, a joystick, a touch surface or touchpad, a voice input device (e.g., microphone or other sound transducer), an image/video acquisition device, a hand gesture recognition device, a scanning device, or another physical device, that provides input to the computing environment 500. The input unit(s) 550 can also include a virtual input interface. Examples of the virtual interface can include, without limiting, the virtual keyboard 80 that is generated by the system 100 as described above. The output unit(s) 560 may be a display (e.g., the display unit 40 shown in FIG. 1), a printer, a speaker, a CD-writer, or another device that provides output from the computing environment 500.

The communication connection(s) 570 enable wired or wireless communication over a communication medium (e.g., a connecting network) to another computing entity. The communication medium conveys information such as computer-executable instructions, compressed graphics information, or other data in a modulated data signal.

Tangible machine-readable media are any available, tangible media that can be accessed within a computing environment 500. By way of example, and not limitation, with the computing environment 500, computer-readable media include memory 520, storage 540, communication media (not shown), and combinations of any of the above. Tangible computer-readable media exclude transitory signals.

### XIII. Other Embodiments

The examples described above generally concern systems and methods for providing user input via a virtual keyboard as an expedient. Such virtual keyboards can be used for AR or VR technology. Nonetheless, embodiments of virtual input interfaces other than those described above in detail are contemplated based on the principles disclosed herein, together with any attendant changes in configurations of the respective system and methods described herein. As but one particular example, the virtual input interface can be a virtual mouse (or a virtual joystick) having a plurality of buttons and/or scrolling wheels that are targets for highlighting and/or selecting by the user in order to operate the virtual mouse (or the virtual joystick).

Directions and other relative references, e.g., up, down, left, right, centroid, etc., may be used to facilitate discussion of the drawings and principles herein, but are not intended to be limiting. For example, certain terms may be used such as “upper,” “lower,” “horizontal,” “vertical,” “top”, “bottom,” and the like. Such terms are used, where applicable, to provide some clarity of description when dealing with relative relationships, particularly with respect to the illustrated embodiments. Such terms are not, however, intended to imply absolute relationships, positions, and/or orientations. As used herein, “and/or” means “and” or “or”, as well as “and” and “or.” Moreover, all patent and non-patent literature cited herein is hereby incorporated by reference in its entirety for all purposes.

The principles described above in connection with any particular example can be combined with the principles described in connection with another example described herein. Accordingly, this detailed description shall not be construed in a limiting sense, and following a review of this disclosure, those of ordinary skill in the art will appreciate the wide variety of signal processing techniques that can be devised using the various concepts described herein.

Moreover, those of ordinary skill in the art will appreciate that the exemplary embodiments disclosed herein can be adapted to various configurations and/or uses without departing from the disclosed principles. Applying the principles disclosed herein, it is possible to provide a wide variety of systems adapted to use a virtual keyboard for user input, such as in a meeting presentation system, game consoles, and so on.

The previous description of the disclosed embodiments is provided to enable any person skilled in the art to make or use the disclosed innovations. Various modifications to those embodiments will be readily apparent to those skilled in the art, and the generic principles defined herein may be applied to other embodiments without departing from the spirit or scope of this disclosure. Thus, the claimed inventions are not intended to be limited to the embodiments shown herein, but are to be accorded the full scope consistent with the language of the claims, wherein reference to an element in the singular, such as by use of the article “a” or “an” is not intended to mean “one and only one” unless specifically so stated, but rather “one or more”. All structural and functional equivalents to the features and method acts of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

Thus, in view of the many possible embodiments to which the disclosed principles can be applied, we reserve to the right to claim any and all combinations of features and technologies described herein as understood by a person of ordinary skill in the art, including, for example, all that comes within the scope and spirit of the following claims.

We currently claim:

1. A method for providing virtual input, the method comprising:
generating a plurality of image frames of a touchpad and a user's hand(s) adjacent to the touchpad;
generating a user perceivable representation of a virtual input interface;
detecting from the plurality of image frames one or more pointing devices associated with the user's hand;
determining from the plurality of image frames a respective candidate target corresponding to each position of the one or more detected pointing devices;
highlighting each respective candidate target determined from the plurality of image frames;
detecting a respective touch point on the touchpad corresponding to each touch by one of the pointing devices on the touchpad; and
determining a selected target by comparing the detected touch point with each respective candidate target determined from the plurality of image frames.

2. The method according to claim 1, wherein the determined candidate target has a first coordinate position relative to the touchpad, the detected touch point has a second coordinate position relative to the touchpad, and the act of comparing the determined candidate target with the detected touch point comprises calculating a distance between the first coordinate position and the second coordinate position.

3. The method according to claim 2, wherein the selected target is the candidate target whose first coordinate position has a smallest distance to the second coordinate position among all determined candidate targets.

4. The method according to claim 1, wherein the virtual input interface has a shape that is substantially identical to a shape of the touchpad, and the virtual input interface has a dimension that is proportional to a dimension of the touchpad, such that each point on the virtual input interface corresponds to a unique point on the touchpad and each point on the touchpad corresponds to a unique point on the virtual input interface, and the virtual input interface has a layout of predefined targets wherein each target corresponds to a two dimensional area on the touchpad.

5. The method according to claim 1 further comprising detecting a shape of the touchpad in the plurality of image frames and detecting a marker on the touchpad, and determining a target layout on the virtual input interface corresponding to the detected shape of the touchpad and the detected marker on the touchpad, wherein the marker is displayable on the touchpad and can be updated by the user.

6. The method according to claim 1, wherein the act of determining the respective candidate target comprises detecting a plurality of hover targets from the plurality of image frames, wherein each hover target is detected from a corresponding image frame based on the position of the corresponding pointing device relative to the touchpad.

7. The method according to claim 6, wherein the candidate target is selected from the plurality of detected hover targets if the selected hover target satisfies a predetermined set of rules.

8. The method according to claim 7, wherein the predetermined set of rules describe a sequential pattern of and/or timing relationship between the plurality of hover targets detected from the plurality of image frames.

9. The method according to claim 1, further comprising displaying the user perceivable representation of the virtual input interface on a head-mounted device.

10. The method according to claim 1, wherein the act of highlighting the candidate target comprises generating a user perceivable representation of the candidate target based on a confidence score associated with the candidate target, wherein the confidence score measures a likelihood that the user intends to point to the candidate target using one of the pointing devices.

11. A system for providing virtual input, the system comprising:
a camera adapted to generate a plurality of image frames of the touchpad and a user's hand(s) adjacent to the touchpad;
a keyboard projector adapted to generate a user perceivable representation of a virtual input interface;
a pointer detector adapted to detect from the plurality of image frames one or more pointing devices associated with the user's hand;
a key detector adapted to determine from the plurality of image frames a respective candidate target corresponding to each position of the one or more detected pointing devices;
a key highlighter adapted to highlight each respective candidate target determined from the plurality of image frames;
a touchpad adapted to detect a respective touch point on the touchpad corresponding to each touch by one of the pointing devices on the touchpad; and
a comparator adapted to determine a selected target by comparing the detected touch point with each respective candidate target determined from the plurality of image frames.

12. The system according to claim 11, wherein the determined candidate target has a first coordinate position relative to the touchpad, the detected touch point has a second coordinate position relative to the touchpad, and the act of comparing the determined candidate target with the detected touch point comprises calculating a distance between the first coordinate position and the second coordinate position.

13. The system according to claim 12, wherein the selected target is the candidate target whose first coordinate position has a smallest distance to the second coordinate position among all determined candidate targets.

14. The system according to claim 11, wherein the virtual input interface has a shape that is substantially identical to a shape of the touchpad, and the virtual input interface has a dimension that is proportional to a dimension of the touchpad, such that each point on the virtual input interface corresponds to a unique point on the touchpad and each point on the touchpad corresponds to a unique point on the virtual input interface, and the virtual input interface has a layout of predefined targets wherein each target corresponds to a two dimensional area on the touchpad.

15. The system according to claim 11 further comprising a touchpad detector adapted to detect a shape of the touchpad in the plurality of image frames and detect a marker on the touchpad, and determine a target layout on the virtual input interface corresponding to the detected shape of the touchpad and the detected marker on the touchpad, wherein the marker is displayable on the touchpad and can be updated by the user.

16. The system according to claim 11, wherein the key detector is adapted to detect a plurality of hover targets from the plurality of image frames, wherein each hover target is detected from a corresponding image frame based on the position of the corresponding pointing device relative to the touchpad.

17. The system according to claim 16, wherein the key detector is adapted to select the candidate target from the plurality of detected hover targets if the selected hover target satisfies a predetermined set of rules.

18. The system according to claim 17, wherein the predetermined set of rules describe a sequential pattern of and/or timing relationship between the plurality of hover targets detected from the plurality of image frames.

19. The system according to claim 11, further comprising a display unit adapted to display the user perceivable representation of the virtual input interface on a head-mounted device.

20. The system according to claim 11, wherein the determined candidate target is highlighted by a user perceivable representation of the candidate target based on a confidence score associated with the candidate target, wherein the confidence score measures a likelihood that the user intends to point to the candidate target using one of the pointing devices.
